(19) United States
(12) Patent Application Publication
(10) Pub. No.: US 2015/0049221 A1
(43) Pub. Date: Feb. 19, 2015

(54) METHOD AND APPARATUS FOR PRE-PROCESSING VIDEO FRAMES

(71) Applicant: MOTOROLA MOBILITY LLC, Libertyville, IL (US)

(72) Inventor: Russell W. Knize, Palatine, IL (US)

(73) Assignee: MOTOROLA MOBILITY LLC, Libertyville, IL (US)

(21) Appl. No.: 13/969,729

(22) Filed: Aug. 19, 2013

(51) Int. Cl. H04N 5/357

(52) U.S. Cl. CPC H04N 5/357
USPC 348/241; 348/607

(57) ABSTRACT

A video device continuously monitors the current frame rate and the speed of its processor to determine how much pre-processing the device can carry out on each individual frame. Based on this knowledge, the device continuously adjusts the pre-processing methodology in order to ensure that processing is completed before the next frame is likely to arrive. The device may carry out these adjustments on raw video frames received from the video capture unit (e.g., the camera of a smartphone).

### FIELD OF THE DISCLOSURE

The present disclosure is related to video pre-processing and, more particularly, to applying a pre-processing methodology to a video frame based on predetermined criteria.

### BACKGROUND

Before encoding a video frame or rendering it on a display, most modern video devices pre-process the video frame in order to make it sharper, less jittery, etc. Common pre-processing methodologies include noise filtering (e.g., spatial filtering or temporal filtering) and motion compensation (e.g., image stabilization).

There are practical limits on how much pre-processing a device can carry out, however. One limitation is the frame rate, which is typically expressed as Frames Per Second (“FPS”). The higher the frame rate, the less time the device has to process (i.e., convert a raw image into a usable format) each individual video frame. Another limitation is the speed of the processor or processors (e.g., Image Signal Processor (“ISP”) or Applications Processor (“AP”)) being used to process the video. Processing speed is typically expressed as a frequency in units of Megahertz (“MHz”) or Gigahertz (“GHz”). There are many well-known techniques for measuring the frame rate and the processor speed.

On platforms that use frequency scaling, the processing speed is not consistent, as it is often reduced due to power and thermal constraints. Furthermore, the frame rate can vary as a result of automatic exposure adjustments. As a result, it may be necessary to limit pre-processing to the worst-case scenario, i.e., assuming the highest frame rate at the lowest possible processing speed.

External conditions being experienced by the video device, such as ambient light levels and temperature, also affect the frame rate or processing speed.

### BRIEF DESCRIPTION OF THE DRAWINGS

Features of the present techniques, together with their objects and advantages, may be best understood from the following detailed description taken in conjunction with the accompanying drawings of which:

FIG. 1 is an overview of an image processing system in which the methods of this disclosure may be practiced; and

FIG. 2 is a flowchart showing steps that are carried out according to an embodiment of the disclosure.

### DETAILED DESCRIPTION

Turning to the drawings, wherein like reference numerals refer to like elements, the following description is based on embodiments of the claims and should not be taken as limiting the claims with regard to alternative embodiments that are not explicitly described herein.

The present disclosure describes a method for pre-processing video that dynamically adjusts the pre-processing methodology for each video frame during video capture in order to account for external conditions (e.g., light and temperature) or system limitations (e.g., thermal constraints on power dissipation).

In one embodiment, a video device continuously monitors the current frame rate and the speed of the processor to determine how much pre-processing the device can carry out on each individual frame. Based on this knowledge, the device continuously adjusts the pre-processing methodology in order to ensure that processing is completed before the next frame is likely to arrive. The device may carry out these adjustments on raw video frames received from the video capture unit (e.g., the camera of a smartphone), which often need additional processing.

In one embodiment, the method takes advantage of the flexibility and modularity of pre-processing activities in general. For each frame, the device can add, cease, or reconfigure certain image pre-processing methodologies in order to optimize the video quality for different external conditions (ambient light levels, temperature, etc.), different processing speeds, and different power constraints. For example, the device can, for each video frame, change noise filter strengths and change the amount of video stabilization it applies. In this embodiment, the device has the capability to monitor internal systems (e.g., monitor thermal indicators) and respond quickly (e.g., on each video frame) to such changes, thereby allowing the device to balance performance with video quality in real time.

In an embodiment of the disclosure, a video device selects a pre-processing methodology for each video frame that it captures by using a scoring system. The scoring system takes into account one or more of (1) the current frame rate, (2) the current processor speed, and (3) external conditions.

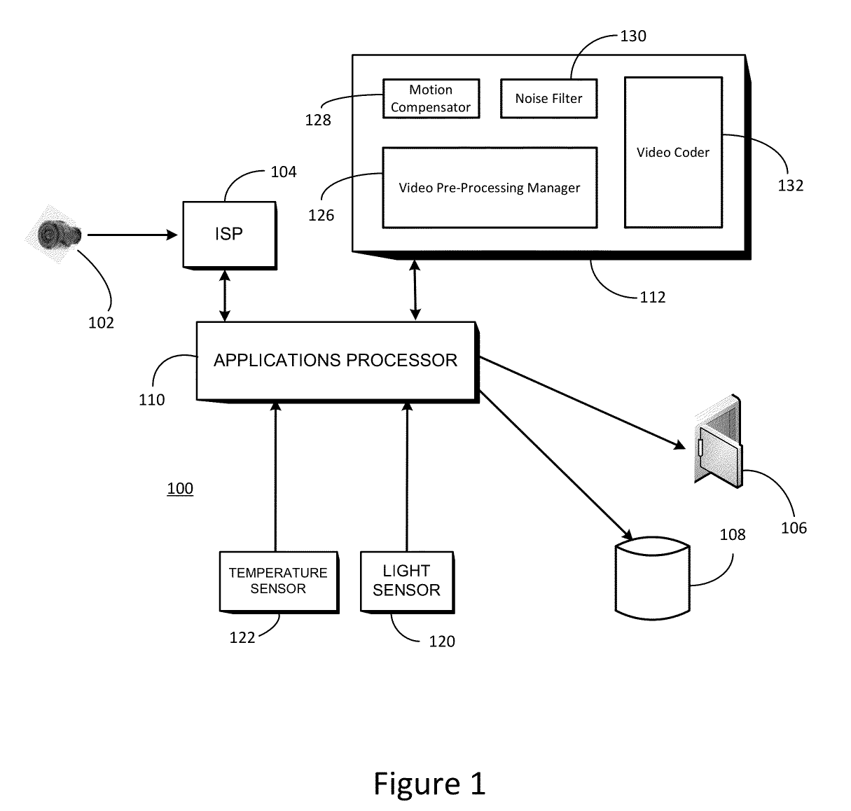

Referring to FIG. 1, the video device (“device”), generally labeled 100 can be any of a variety of devices that include a video capture component, such as a smartphone, standalone digital camera, or standalone video camera, to name a few. The device 100 includes a video capture unit 102, an image signal processor (“ISP”) 104, a video display 106 (e.g., an LCD display), non-volatile storage media 108 (e.g., a Secure Digital card), and an Applications Processor (“AP”) 110. The AP 110 can be implemented as any suitable piece of hardware, including a digital signal processor, a graphics processor, or as part of a system-on-a-chip.

According to an embodiment, the video capture unit 102 is an assembly that includes a lens and a charge-coupled device image sensor.

The AP 110 carries out functions, including the methods described herein, using instructions and data (e.g., programs, routines, methods, and libraries) that are stored in an on-board memory 112 of the device 100. The on-board memory 112 can be integrated with the AP 110, be separate from the AP 110, or be a combination of integrated and separate memory. The on-board memory 112 can be a volatile memory or a non-volatile memory.

In one embodiment, the on-board memory 112 includes both volatile and non-volatile memory. The instructions and data are stored in a non-volatile computer-readable medium (e.g., electrically erasable programmable read-only memory) and loaded into the volatile memory (e.g., dynamic random access memory) for processing and execution by the AP 110.

The device 100 also includes a light sensor 120 and a temperature sensor 122, both of which are communicatively linked to the AP 110. The device 100 may also include other types of sensors known in the art. In some embodiments, the video capture unit 102 also functions a light sensor. Thus, when this disclosure refers to the light sensor 120 carrying out an action, it is to be understood that the video capture unit 102 can be substituted for the light sensor 120.

According to an embodiment of the disclosure, the methods described herein are carried out by a video pre-processing manager 126, which is resident in the on-board memory 112. Furthermore, this disclosure often refers to the video pre-processing manager 126 as carrying out actions. One meaning of this phraseology is the AP 110 itself carrying out the actions. Another meaning is a dedicated piece of hardware physically separate from the AP 110 carrying out the actions. Yet another meaning is one or more discrete sections of a system-on-chip carrying out the actions.

A motion compensator 128, noise filter 130, and video coder 132 are also resident in the on-board memory 112. The video pre-processing manager 126, motion compensator 128, and noise filter 130 are shown as being distinct pieces of software in FIG. 1. Their functions may, however, all be carried out by a single program. As with the video pre-processing manager 126, the motion compensator 128 and the noise filter 130 may be implemented as separate pieces of hardware (dedicated processors, filters, codecs, etc.)

The noise filter 130 is capable of filtering images temporally and spatially. The motion compensator 128 reduces the impact of the video device 100 being moved while the video capture unit 102 is capturing images (video frames). The video coder 132 converts raw images (still or moving) into a standardized format, such as H.264.

In an embodiment, the video capture unit 102, in combination with the ISP 104, captures a series of video frames and provides each video frame of the series to the AP 110. The AP 110 receives sensor data from the light sensor 120 and temperature sensor 122. The AP 110 takes the sensor data, calculates a score based on one or more of (1) the current frame rate, (2) the current processor speed, and (3) the sensor data (i.e., data regarding the external conditions), and selects one or more pre-processing methodologies to apply to the video frame based on that score. One possible methodology is simply to pass the video frame to the display 106 or to the video coder 132 without any pre-processing. The AP 110 then acts according to the selected methodology. In other words, the AP 110 (1) pre-processes the video frame using one or more pre-processing techniques, or (2) refrains from pre-processing the video frame. The AP 110 then provides the video frame (pre-processed or not) either to the display 106 (which displays the image) or to the video coder 132. The video coder 132 encodes the image (e.g., as an H.264 video frame) and stores the encoded image in the non-volatile storage media 108. The AP 110 repeats this process for each video frame.

An example of a scoring mechanism that the video pre-processing manager 126 may use is as follows:
FR is the frame rate;
MAX is the maximum processor speed (e.g., the current processor speed);
IV is the initial value;

SCORE is the calculated score;

Assign SCORE the value IV;

If FR<15 FPS, then increment SCORE by 2;

If 15≦FR<25 FPS, then increment SCORE by 1;

If MAX<1.0 GHz, then decrement SCORE by 3;

If 1.0≦MAX<1.4 GHz, then decrement SCORE by 2;

If 1.4 GHz≦MAX<1.6 GHz, then decrement SCORE by 1;

The initial value IV can be set based on the number of frames waiting to be processed, and may differ depending on whether the video frame is being sent to the display 106 or to the storage media. For example, if the video pre-processing manager 126 receives frames faster than it can process them such that the number frames waiting to be processed is increasing, IV may set lower than it would be otherwise.

In another example, if the system designer wished to focus on the speed (i.e., avoidance of dropped frames) of the real-time display of the video as opposed to that of the stored video, IV would be set lower for the displaying mode than the recording mode.

Ways of determining FR and MAX are well known by persons of ordinary skill in the art and therefore will not be discussed herein.

The video pre-processing manager 126 may also increment or decrement SCORE based on sensor data. For example, it could increment SCORE at high light levels and decrement SCORE at low light levels. Conversely, it could decrement SCORE at higher temperatures and increment SCORE at lower temperatures.

The pre-processing manager 126 selects a pre-processing methodology based on the calculated score. One way of doing this is as follows:

If SCORE≧0, then perform temporal filtering and spatial filtering;

If SCORE=−1, then perform temporal filtering, but not spatial filtering (e.g., disable spatial filtering);

If SCORE=−2, then perform spatial filtering, but not temporal filtering (e.g., disable temporal filtering);

If SCORE≦−3, then carry out no pre-processing (e.g., disable temporal and spatial filtering and send the video frame straight to the video coder 132);

Although the above example depicts SCORE as being calculated based on both FR and MAX, SCORE may also be calculated using only FR or using only MAX.

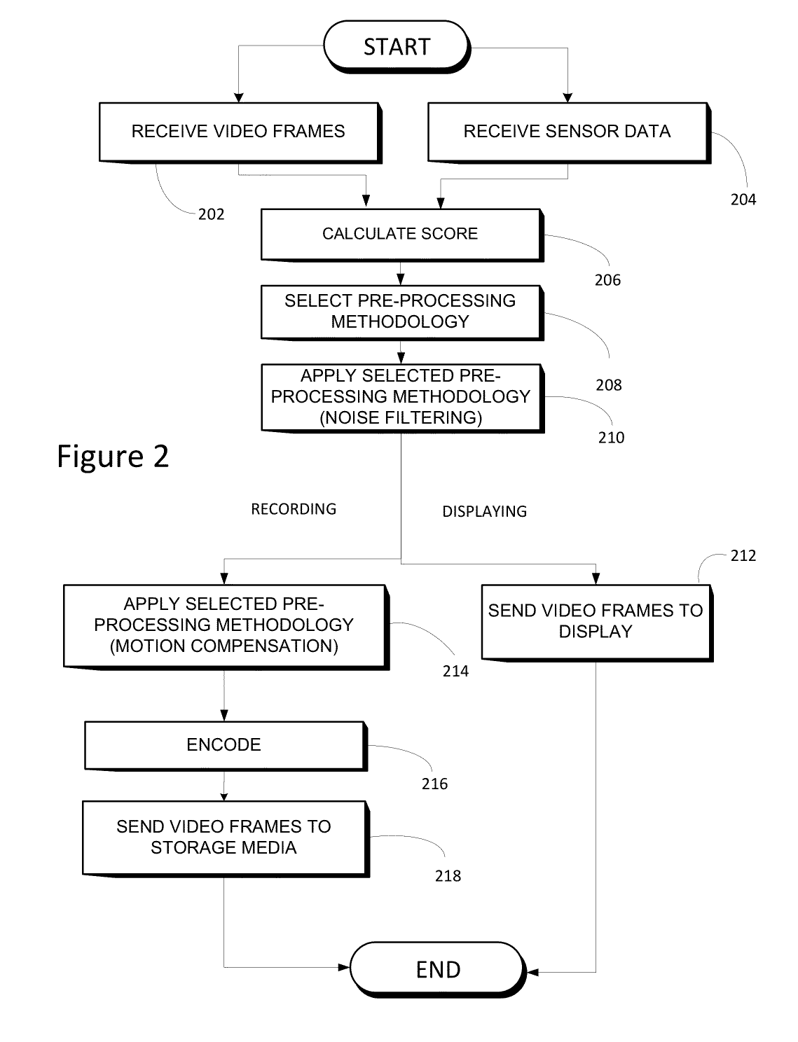

Turning to FIG. 2, a flowchart illustrating an embodiment of the method of adjusting video processing methodology will be described. During the method, the AP 110 executes the video pre-processing manager 126 to perform the following acts. At block 202, the AP 110 receives video frames from the ISP 104 at a frame rate FR. In parallel with block 202, the AP 110 receives data regarding external conditions—i.e., humidity data from humidity sensor 116, motion data from motion sensor 118, ambient light data from the light sensor 120, temperature data from the temperature sensor 122, and orientation data from the orientation sensor 124 (block 204). At block 206, the AP 110 calculates SCORE based on the sensor data, MAX, and FR. For example, using the scoring system set forth above, if IV is 1, FR is 17 FPS, MAX is 1.3 GHz, then SCORE would be 1+1 −2=0. At block 208, the AP 110 selects a pre-processing methodology based on the SCORE. Continuing with the example, if SCORE=0, the AP 110 would select both spatial and temporal filtering.

At block 210, the AP 110 applies the selected pre-processing methodology with regard to noise filtering. In other words, the AP 110 sets the noise filter 130 to filter noise of the video frame as determined by the selected methodology. This includes possibly refraining altogether from filtering noise. In the example above, AP 110 would set the noise filter so as to carry out both spatial and temporal filtering.

If the device 100 is in the display mode, the method proceeds down the path that includes block 212. In record mode, the device 100 both displays and records. Thus, if the device 100 is in the record mode, the method proceeds down both paths—the path that includes block 212 as well as the path that includes blocks 214, 216, and 218.

At block 212, the AP 110 sends the pre-processed video frames (or raw video frames, as the case may be) to the display 106. At step 214, the AP 110 applies the selected pre-processing methodology with regard to motion compensation. In other words, the AP 110 sets the motion compensator to pre-process the video frame for motion as determined by the selected methodology. This includes possibly refraining altogether from compensating for motion. For example, if the FR is high and MAX is low (e.g., SCORE is less than or equal to −3), then the AP 110 could refrain from carrying out any motion compensation, i.e., turn off motion compensation. At block 216, the AP 110 encodes the video frames using the video coder 132. Finally, at block 218, the AP 110 stores the encoded video frames in the removable memory 108.

The blocks of FIG. 2 are set forth in an order that is consistent with an embodiment of the disclosure. In other embodiments, however, the blocks may be ordered differently. In one embodiment, blocks 206, 208, and 210 are carried out for each of the displaying mode and the recording mode, such that there may be two different values of SCORE—one for displaying mode and one for recording mode. In such case, IV can be higher for one than the other, effectively “weighting” SCORE toward displaying or toward recording.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method of pre-processing a plurality of video frames on a video device, the method comprising:
calculating a score based on a speed of a processor of the video device;
selecting a pre-processing methodology based on the calculated score; and
applying the selected methodology to a video frame of the plurality of video frames.

2. The method of claim 1, wherein selecting a pre-processing methodology comprises determining how to apply noise filtering to the video frame.

3. The method of claim 1,
wherein selecting a pre-processing methodology comprises determining not to apply temporal filtering to the video frame; and
wherein applying the selected methodology comprises refraining from temporal filtering the video frame.

4. The method of claim 1,
wherein determining a pre-processing methodology comprises determining not to apply spatial filtering to the video frame; and
wherein applying the selected methodology comprises refraining from spatial filtering the video frame.

5. The method of claim 1, further comprising calculating the score based additionally on a rate at which the video device is capturing the plurality of video frames.

6. The method of claim 1, further comprising:
receiving data regarding the environment of the video device from a sensor of the video device; and
calculating the score based additionally on the environment data.

7. The method of claim 1, further comprising repeating the calculating, selecting, and applying for each of the plurality of video frames.

8. The method of claim 1,
wherein determining a pre-processing methodology comprises determining to apply neither spatial filtering nor temporal filtering to the video frame;
wherein applying the selected methodology comprises refraining from spatial filtering and from temporal filtering the video frame.

9. The method of claim 1, wherein selecting a pre-processing methodology comprises determining how to apply motion compensation to the video frame.

10. The method of claim 1,
wherein selecting a pre-processing methodology comprises determining not to apply motion compensation to the video frame; and
wherein applying the selected methodology comprises refraining from compensating for motion of the video frame.

11. A method of pre-processing a plurality of video frames on a video device, the method comprising:
calculating a score based on a rate at which the video device is capturing the plurality of video frames;
selecting a pre-processing methodology based on the calculated score; and
applying the selected methodology to a video frame of the plurality of video frames.

12. The method of claim 11, wherein selecting a pre-processing methodology comprises determining how to apply noise filtering to video frame.

13. The method of claim 11,
wherein selecting a pre-processing methodology comprises determining not to apply temporal filtering to the video frame; and
wherein applying the selected methodology comprises refraining from temporal filtering the video frame.

14. The method of claim 11,
wherein determining a pre-processing methodology comprises determining not to apply spatial filtering to the video frame; and
wherein applying the selected methodology comprises refraining from spatial filtering the video frame.

15. The method of claim 11, further comprising:
receiving data regarding the environment of the video device from a sensor of the video device; and
calculating the score based additionally on the environment data.

16. The method of claim 11, wherein selecting a pre-processing methodology comprises determining how to apply motion compensation to the video frame.

17. The method of claim 11,
wherein selecting a pre-processing methodology comprises determining not to apply motion compensation to the video frame; and
wherein applying the selected methodology comprises refraining from compensating for motion of the video frame.

18. A video device comprising:
a video capture unit;
non-volatile storage media;
a display; and
an applications processor communicatively linked to the video capture unit, the non-volatile storage media, and the display,
wherein the applications processor is configured to:
receive a plurality of video frames from the video capture unit;
calculate a score based on a speed of the applications processor;
select a pre-processing methodology based on the calculated score; and
apply the selected pre-processing methodology to a video frame of the plurality of video frames.

19. The video device of claim 18, wherein the applications processor is further configured to calculate the score based additionally on a rate at which the video device is capturing the plurality of video frames.

20. The video device of claim 18, wherein the applications processor is further configured to:
receive data regarding the environment of the video device from a sensor of the video device; and
calculate the score based additionally on the environment data.
